(19) United States
(12) Patent Application Publication
(10) Pub. No.: US 2026/0092678 A1
(43) Pub. Date: Apr. 2, 2026

(54) Smart Home Device Utilizing Tension Rod

(71) Applicant: MAOYUN GUO, SHENZHEN (CN)

(72) Inventor: MAOYUN GUO, SHENZHEN (CN)

(21) Appl. No.: 18/945,815

(22) Filed: Nov. 13, 2024

(30) Foreign Application Priority Data
Sep. 27, 2024 (CN) 202422364388.5

(51) Int. Cl. F16M 13/02; G08C 17/02; H04W 84/02

(52) U.S. Cl. CPC F16M 13/022; G08C 17/02; H04W 84/02

(57) ABSTRACT

The present utility model discloses a smart home device comprising a retractable tension rod, a wireless control box mounted on the retractable tension rod, and a functional execution module. The functional execution module is connected to the wireless control box. The retractable tension rod includes a first end and a second end, which can be tightly pressed against two building surfaces using tension, thereby suspending the smart home device between the two surfaces. The wireless control box receives external commands wirelessly and controls the functional execution module to operate accordingly. This utility model allows for the quick and convenient installation of smart home products without damaging walls or ceilings, eliminating the need for construction workers or electricians. It avoids the complex steps of wall slotting, drilling, wiring, and post-installation repairs. Furthermore, this utility model integrates multiple functional units, reducing both maintenance and upgrade costs.

### 1. TECHNICAL FIELD

The present utility model relates to the field of Internet of Things (IoT) smart home devices, and more specifically, to a smart home device with a tension rod.

### 2. DESCRIPTION OF RELATED ART

Current IoT smart home products on the market are primarily focused on ceiling or wall-mounted devices, such as smart lighting and surveillance cameras. These traditional installation methods typically require wall grooving, drilling, and wiring, which not only necessitate professional construction workers and electricians but also extend the construction period and increase costs.

According to market research, the installation costs of traditional wall-mounted devices account for approximately 25% to 38% of the total expenses, and the user complaint rate due to installation complexities exceeds 15%. Additionally, the functional integration of existing products is relatively low, with multiple functions scattered across different devices, increasing initial procurement costs and negatively affecting the user experience. This also leads to higher maintenance and upgrade costs later on. Statistics show that the maintenance and upgrade costs of dispersed devices are about 40% higher than those of integrated devices.

Thus, the current IoT smart home products face numerous installation challenges, such as wall damage, dependence on professional construction, high installation costs, long construction periods, and inefficient space utilization. At the same time, the low level of functional integration complicates maintenance and upgrades, making them more difficult and expensive.

Therefore, there is a need for improvement in the existing technology.

### SUMMARY

The present utility model discloses a smart home device comprising a retractable tension rod, a wireless control box mounted on the retractable tension rod, and a functional execution module. The functional execution module is connected to the wireless control box. The retractable tension rod includes a first end and a second end, which can be tightly pressed against two building surfaces using tension, thereby suspending the smart home device between the two surfaces. The wireless control box receives external commands wirelessly and controls the functional execution module to operate accordingly. This utility model allows for the quick and convenient installation of smart home products without damaging walls or ceilings, eliminating the need for construction workers or electricians. It avoids the complex steps of wall slotting, drilling, wiring, and post-installation repairs. Furthermore, this utility model integrates multiple functional units, reducing both maintenance and upgrade costs.

The technical solution adopted for solving technical problems of the present disclosure is:

In view of the shortcomings of the prior art, the objective of the present invention is to provide a tension rod smart home device, aimed at enabling non-destructive, quick, and convenient installation of smart home products. This eliminates the need to damage walls or ceilings, and avoids the need for construction workers or electricians to perform complex installation processes, thus avoiding the tedious steps of wall grooving, drilling, wiring, and subsequent restoration.

To achieve the above objective, the present invention proposes a tension rod smart home device, which includes a retractable tension rod, a wireless control box mounted on the retractable tension rod, and a functional execution module. The functional execution module is electrically connected to the wireless control box. The retractable tension rod consists of a first end and a second end located at either end, which can be tightly pressed against two building surfaces through tension, suspending the tension rod smart home device between the two building surfaces. After receiving external instructions wirelessly, the wireless control box controls the operation of the functional execution module.

In some examples, the suspension can be vertical, horizontal, or diagonal.

In some examples, the functional execution module includes one or more of a lamp module, audio module, or sensor module.

In some examples, the retractable tension rod includes a main rod and an adjustment rod connected to the main rod. The adjustment rod has axial elasticity and can be inserted into the main rod with adjustable insertion length.

In some examples, the main rod is composed of several detachable short rods connected together.

In some examples, the end of the main rod that contacts the building surface is provided with a rotatable main rod base, and the end of the adjustment rod that contacts the building surface is provided with a rotatable adjustment rod base.

In some examples, the adjustment rod includes a locking base, a spring, and an ejection rod connected sequentially. The locking base and spring are located inside the main rod, and one end of the ejection rod is located inside the main rod while the other end extends outside the main rod.

Multiple adjustment holes are distributed axially on the main rod. The locking base is provided with an ejection ball, which, after being embedded in the adjustment holes, fixes the locking base to the main rod.

In some examples, the wireless control box includes a main control circuit module, a wireless network module electrically connected to the main control circuit module, and an expansion drive interface. The expansion drive interface is electrically connected to the functional execution module.

The wireless control box also includes a power supply module that provides power to the main control circuit module, the wireless network module, the expansion drive interface, and the functional execution module.

In some examples, the main control circuit module includes a microprocessor and a memory unit electrically connected to the microprocessor. The memory unit stores an operating system and applications.

In some examples, the expansion drive interface includes one or more of SPI, I2C, USB, GPIO, or UART interfaces.

In some examples, the wireless network module includes one or more of a WiFi module, Bluetooth module, LoRa module, ZigBee module, or NB-IoT module.

In some examples, the lamp module includes a PCB metal heat sink substrate, a light-emitting unit arranged on the PCB metal heat sink substrate, an optical component, and a lampshade that covers the PCB metal heat sink substrate, the light-emitting unit, and the optical component. The optical component is positioned in the direction where light is emitted from the light-emitting unit.

In some examples, the light-emitting unit includes an illumination light source, and one or more of an ultraviolet light source, infrared light source, or laser light source.

In some examples, the optical component includes one or more of a lens, Fresnel lens, optical film, reflective condensing cover, or grating that shapes and controls the light.

In some examples, the sensor module includes one or more of a microphone, light sensor, camera, or infrared sensor.

It should be understood that within the scope of the present invention, the above-mentioned technical features and those described in detail below (such as in the embodiments) can be combined with each other to form new or preferred technical solutions. Due to space limitations, these combinations are not described in detail here.

### Beneficial Effects of the Utility Model

The tension rod smart home device of the present utility model overcomes the shortcomings of the prior art through its damage-free installation method and highly integrated design. Users do not need to damage walls or ceilings, nor do they need construction workers or electricians to carry out complex installations, thus avoiding the tedious steps of wall grooving, drilling, wiring, and subsequent repairs.

By utilizing a retractable tension rod, users can quickly install and adjust the position and angle of the device, easily achieving damage-free installation.

The device integrates multiple functional units, such as the wireless control box and the functional execution module. The functional execution module can include lighting, audio, and sensors. By installing the device at a higher location in a room, users can achieve extensive environmental sensing from above, receive signals, and enjoy an enhanced audiovisual experience. This greatly improves the overall smart home experience. Additionally, due to the high degree of integration of the device, centralized maintenance in the future significantly reduces maintenance and upgrade costs, in contrast to the scattered maintenance required by existing technologies.

The device has a wide range of applications and can be used in various settings such as homes and offices. It is eco-friendly and economical, reducing construction waste and secondary renovation pollution, while significantly lowering installation costs and shortening installation time.

### BRIEF DESCRIPTION OF THE DRAWINGS

To more clearly illustrate the embodiments of the present utility model or the technical solutions in the prior art, a brief introduction to the drawings used in the description of the embodiments or prior art is provided below. It is evident that the drawings described below are merely some embodiments of the present utility model. For those skilled in the art, other drawings may be derived based on the structures shown in these figures without creative effort.

FIG. 1 is a schematic front view of the overall structure of the tension rod smart home device in a vertical installation according to the first embodiment of the present utility model.

FIG. 2 is a schematic front view of the retractable tension rod structure in FIG. 1.

FIG. 3 is an exploded view of the structure in FIG. 2.

FIG. 4 is a schematic rear view of the overall structure in FIG. 1.

FIG. 5 is a schematic side view of the overall structure in FIG. 1.

FIG. 6 is a schematic diagram of the circuit composition of the tension rod smart home device of the present utility model.

FIG. 7 is a schematic front view of the overall structure of the tension rod smart home device in a horizontal installation according to the second embodiment of the present utility model.

FIG. 8 is a schematic front view of the overall structure of the tension rod smart home device in a horizontal installation according to the third embodiment of the present utility model.

The element labels according to the embodiment of the present disclosure shown as below:

| Number | Name |
|---|---|
| 100 | Retractable Tension Rod |
| 101 | First end |
| 102 | Second end |
| 110 | Main Rod |
| 111 | Short rod |
| 112 | Adjustment hole |
| 120 | Adjustment Rod |
| 121 | Locking base |
| 122 | Spring |
| 123 | Ejection rod |
| 124 | Ejection ball |
| 131 | Adjustment Rod Base |
| 132 | Main Rod Base |
| 200 | Wireless Connection Control |
| | Box |
| 210 | Wireless network module |
| 211 | WiFi module |
| 212 | Bluetooth module |
| 220 | Main Control Circuit Module |
| 221 | Microprocessor |
| 222 | Memory unit |
| 230 | Expansion drive interface |
| 240 | Power supply module |
| 300 | Functional execution |
| | module |
| 310 | Lamp module |
| 311 | Light emitting unit |
| 312 | Optical component |
| 313 | Lampshade |
| 314 | PCB metal heat sink |
| | substrate |
| 320 | Audio module |
| 330 | Sensor module |
| 331 | Microphone |
| 332 | Light sensor |
| 333 | Camera |
| 334 | infrared sensor |
| 400 | Building surface |
| 500 | LED decorative light |
| 511 | LED light bead |
| 512 | LED light board |
| 513 | Light board bracket |
| 600 | Device |

### DETAILED DESCRIPTION

The technical solutions of the embodiments of this utility model will be clearly and completely described below in conjunction with the accompanying drawings. It is evident that the described embodiments are merely part of the embodiments of this utility model and not all of them. Based on the embodiments of this utility model, all other embodiments obtained by those of ordinary skill in the field without creative efforts shall fall within the protection scope of this utility model.

It should be noted that all directional indications (such as up, down, left, right, front, rear, etc.) in the embodiments of this utility model are only used to explain the relative positional relationships and movement situations between components under a specific posture (as shown in the accompanying drawings). If the specific posture changes, the directional indications shall also change accordingly.

Moreover, the descriptions of “first,” “second,” and so on in this utility model are only for descriptive purposes and should not be understood as indicating or implying relative importance or suggesting the number of technical features indicated. Therefore, features defined with “first” or “second” may explicitly or implicitly include at least one such feature. In addition, the use of “and/or” throughout the document includes three options: taking “A and/or B” as an example, it includes the technical scheme of A, the technical scheme of B, and the technical scheme of both A and B. Furthermore, the technical solutions of various embodiments can be combined with each other, but only if such combinations can be realized by those skilled in the art. When a combination of technical solutions results in contradictions or cannot be realized, it should be considered that such a combination does not exist and does not fall within the protection scope claimed by this utility model.

In this utility model, unless explicitly specified otherwise, terms such as “connect,” “fix,” etc., should be broadly understood. For example, “fix” may refer to a fixed connection, a detachable connection, or an integral connection; it may represent a mechanical connection or an electrical connection; it may involve direct connections or indirect connections through intermediate media. It can also refer to internal communication between two components or the interaction between the two components, unless explicitly defined otherwise. Those skilled in the art can understand the specific meanings of the aforementioned terms in this utility model based on the specific context. Furthermore, the technical solutions of various embodiments in this utility model can be combined with each other, but only if such combinations can be realized by those skilled in the art. When a combination of technical solutions results in contradictions or cannot be realized, it should be considered that such a combination does not exist and does not fall within the protection scope claimed by this utility model.

### SPECIFIC IMPLEMENTATION EXAMPLES

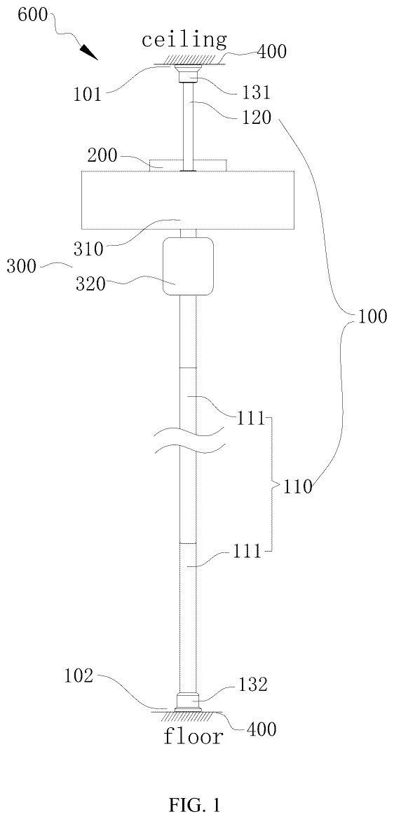

Embodiment 1: Referring to FIGS. 1 to 3, this embodiment of the utility model proposes a tension rod smart home device 600, which is installed vertically in a building. It includes a retractable tension rod 100, a wireless control box 200 arranged on the retractable tension rod 100, and a function execution module 300. The function execution module 300 is electrically connected to the wireless control box 200. The retractable tension rod 100 consists of a first end 101 and a second end 102 located at both ends, which can press against two building surfaces 400 through tension, allowing the tension rod smart home device 600 to be suspended between the two building surfaces 400. The wireless control box 200 controls the function execution module 300 to operate after receiving external commands wirelessly.

The retractable tension rod 100 in this utility model is similar to what is commonly known as a tension rod or ceiling-to-floor rod. Its length is adjustable, and one or both ends can elastically deform to stretch the entire rod tightly between the two building surfaces 400, as shown in FIG. 1. In this embodiment, the retractable tension rod 100 is vertically supported between the ceiling and the floor, with the first end 101 of the tension rod 100 in contact with the ceiling and the second end 102 in contact with the floor. This configuration allows the tension rod smart home device 600 to be suspended between the ceiling and the floor. In this embodiment, the suspension is vertical; in other embodiments, the tension rod smart home device 600 can be suspended horizontally or diagonally.

The wireless control box 200 can be fixed to the retractable tension rod 100 using various fixing methods, such as fastening structures, socket structures, anchoring structures, embedded structures, clamp structures, pin connection structures, threaded connection structures, etc. Depending on the application requirements, the installation position of the wireless control box 200 can be in the middle of the rod, at one end of the rod, at the bottom, or embedded within the rod, thereby meeting different functional needs.

In this utility model, the function execution module 300 includes one or more of the following: the lighting module 310, the audio module 320, and the sensor module 330. The lighting module 310 can emit light for illumination, providing a lighting effect, or it can emit ultraviolet light for sterilization, among other functions. The audio module 320 can play audio, while the sensor module 330 can collect environmental information, such as sound collection, image capture, light intensity measurement, and so on. The components of the function execution module 300—lighting module 310, audio module 320, and sensor module 330—can also be fixed to the retractable tension rod 100 using various methods, such as fastening structures, socket structures, anchoring structures, embedded structures, clamp structures, pin connection structures, threaded connection structures, or even by adhesive methods.

The wireless control box 200 is equipped with a wireless communication module, such as WiFi, LoRa, Bluetooth, ZigBee, NB-IoT, etc., enabling the entire device 600 to connect to the Internet of Things (IoT) and become a smart home system. This allows for intelligent control; users can send control commands wirelessly, which are received by the wireless control box 200 for analysis and judgment. Then, according to these commands, the corresponding parts of the function execution module 300 can be controlled to perform tasks, such as turning the lighting on or off, playing or pausing music, collecting environmental sound and image data, or gathering the status data of home devices for remote transmission to the user.

The tension rod smart home device 600 combines IoT intelligence with the retractable tension rod 100, allowing for a damage-free installation that achieves flexible space utilization and optimizes user experience. It also integrates multiple functions within the function execution module 300. This highly integrated design effectively reduces maintenance and upgrade costs in the future.

Specifically, as shown in FIG. 1, the retractable tension rod 100 in this embodiment includes a main rod 110 and an adjustment rod 120 connected to the main rod 110. The adjustment rod 120 has axial elasticity and is embedded within the main rod 110, with an adjustable embedding length. The adjustment rod 120 is telescopic within the main rod 110, which allows for adjusting the overall length of the retractable tension rod 100 on one hand, while also providing the necessary axial elasticity to maintain tension against the building surfaces 400 on the other.

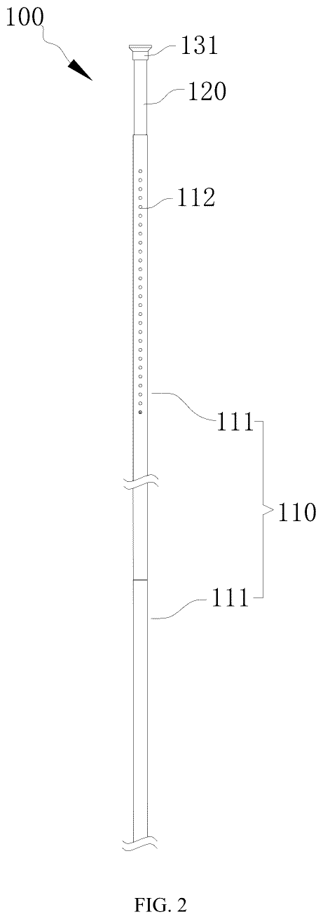

Preferably, as shown in FIGS. 1 and 2, the main rod 110 consists of multiple detachable short rods 111 that are connected end-to-end and can be disassembled. By adjusting the quantity and specifications of the short rods 111, the overall length of the retractable tension rod 100 can be modified to suit different installation spaces and usage requirements. The main rod 110 in this embodiment is equipped with adjustment holes 112 that facilitate the adjustment of the adjustment rod's length.

At one end of the main rod 110 that contacts the building surface 400, a main rod base 132 is provided, and at the end of the adjustment rod 120 that contacts the building surface 400, an adjustment rod base 131 is set, as shown in FIG. 1. The bottom of the main rod 110 is equipped with the main rod base 132, and the top of the adjustment rod 120 has the adjustment rod base 131. When the device 600 in this embodiment is installed vertically, it will contact two building surfaces 400, which are the ceiling and the floor, respectively. The adjustment rod base 131 pushes against the ceiling, while the main rod base 132 presses against the floor. The two building surfaces 400 are parallel and facing each other, allowing for a damage-free installation achieved through the physical tension and friction generated by the retractable tension rod 100. Both the adjustment rod base 131 and the main rod base 132 can increase the contact surface area with the building surface 400, enhancing the firmness and stability of the support.

In other embodiments, a rotatable main rod base 132 can be set at one end of the main rod 110 that contacts the building surface 400, and a rotatable adjustment rod base 131 can be placed at one end of the adjustment rod 120 that contacts the building surface 400. This allows the main rod base 132 to rotate relative to the main rod 110, and the adjustment rod base 131 to rotate relative to the adjustment rod 120, accommodating the installation of the tension rod smart home device 600 on two non-parallel building surfaces 400, such as in an inclined installation.

The main rod base 132 and the adjustment rod base 131 can be made of a soft material, such as rubber, to prevent damage to the building surface 400, like walls. Alternatively, soft components, such as rubber pads, can be placed on the parts of the main rod base 132 and the adjustment rod base 131 that come into contact with the building surface 400.

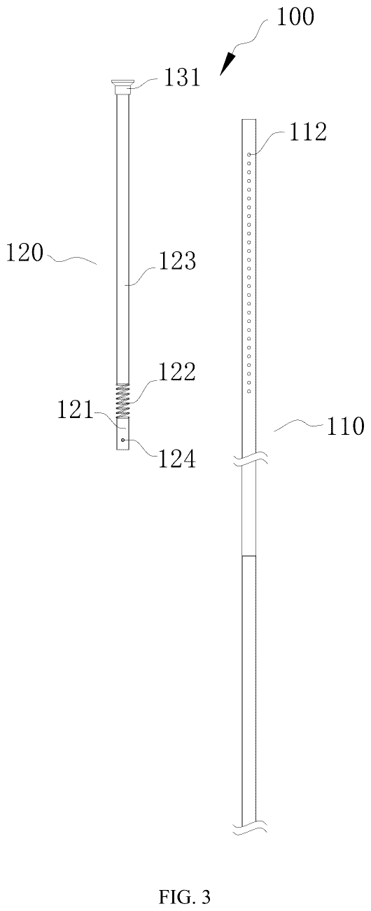

As shown in FIGS. 2 and 3, the adjustment rod 120 in this embodiment consists of a locking base 121, a spring 122, and a push rod 123, which are connected in sequence. The locking base 121 and the spring 122 are located inside the main rod 110, with one end of the push rod 123 positioned inside the main rod 110 and the other end extending outside the main rod 110. The main rod 110 has multiple adjustment holes 112 distributed axially, and the locking base 121 has a push-out ball 124. When the push-out ball 124 is embedded in the adjustment hole 112, the locking base 121 is fixed to the main rod 110.

The locking base 121, spring 122, and a portion of the push rod 123 in the adjustment rod 120 are all embedded within the main rod 110. The push-out ball 124 on the locking base 121 can engage with the adjustment holes 112 located at different positions on the main rod 110, allowing for the adjustment of the length of the push rod 123 within the main rod 110, thus enabling the entire length of the retractable tension rod 100 to be adjusted to accommodate the distance between two building surfaces 400.

In this embodiment, the push-out ball 124 on the locking base 121 can be popped out or retracted by pressing a switch. When the push-out ball 124 on the locking base 121 engages with an adjustment hole 112 on the main rod 110, the push rod 123 can still elastically move relative to the fixed locking base 121, compressing the spring 122 to press the adjustment rod base 131 against the building surface 400.

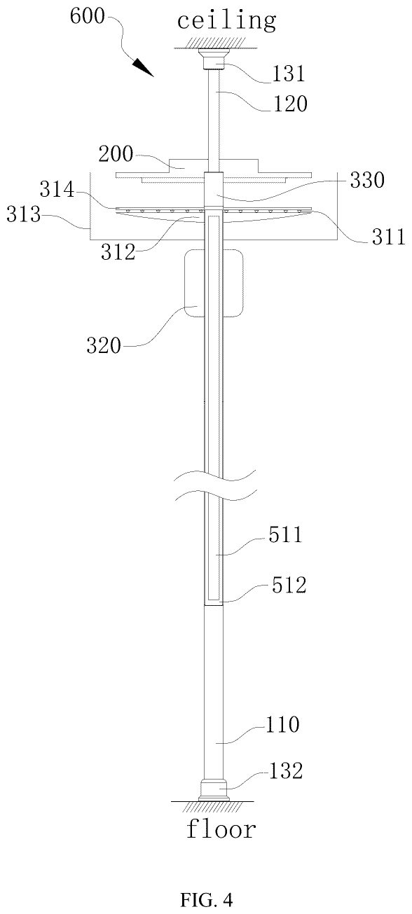

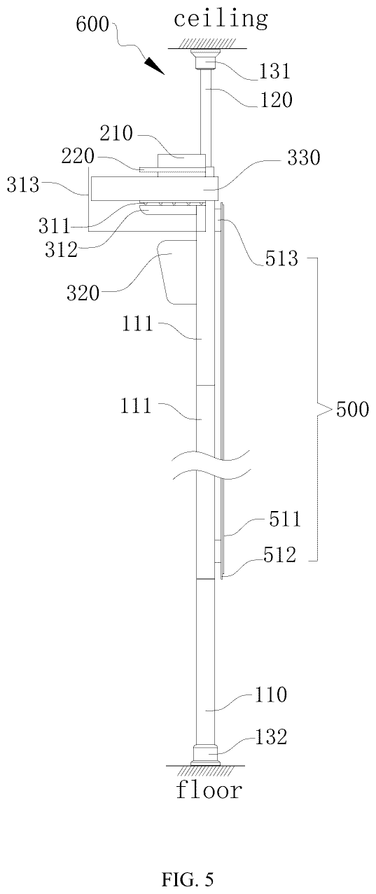

As shown in FIGS. 4 and 5, the functional execution module 300 in this embodiment includes a lighting module 310. The lighting module 310 consists of a PCB metal heat sink substrate 314, a light-emitting unit 311 mounted on the PCB metal heat sink substrate 314, an optical component 312, and a lampshade 313 covering the PCB metal heat sink substrate 314, light-emitting unit 311, and optical component 312. The optical component 312 is positioned in the light-emission direction of the light-emitting unit 311. The PCB metal heat sink substrate 314 and the lampshade 313 are fixed to the retractable tension rod 100. The light-emitting unit 311 is electrically connected to the wireless control box 200 through wires, connecting the power line or relevant signal line.

The light-emitting unit 311 includes an illumination light source and one or more of a UV light source, infrared light source, or laser light source. It can also include other types of light sources. The illumination light source comprises surface light sources and line light sources. These light sources provide uniform or directional lighting based on different scene requirements, meeting various functional needs of users. The UV light source is used for disinfection indoors, ensuring environmental hygiene; the infrared light source can be used for control signals or time-space signal transmission; and the laser light source can be utilized for spatial measurement or time-space signals, or to create unique atmospheric effects to enhance the enjoyment of life.

The optical component 312 includes lenses, Fresnel lenses, optical films, reflective concentrators, or gratings, which shape and control the light. These optical components 312 can accurately control the propagation direction and focus of the light, providing users with ideal lighting effects and atmosphere.

The PCB metal heat sink substrate 314 is used to rapidly dissipate heat generated by the light-emitting unit 311, ensuring the stable operation of the lighting module 310. The substrate can also conduct heat to the tension rod 100 through insulating materials for further heat dissipation, effectively extending the lifespan of the lighting module 310.

The lampshade 313 not only enhances the overall aesthetic effect of the device but also serves to control the range of light and functions as a connecting or fixing component.

As shown in FIGS. 1, 4, and 5, the functional execution module 300 in this embodiment also includes an audio module 320 fixed to the retractable tension rod 100, which is electrically connected to the wireless control box 200 through wires, connecting the power line or relevant signal line. The audio module 320 contains an audio housing, speaker unit, and shock-absorbing sound insulation materials, supporting high-fidelity audio playback, and providing users with an immersive auditory experience.

As shown in FIGS. 4 and 5, the functional execution module 300 in this embodiment also includes a sensor module 330 fixed to the retractable tension rod 100, which is electrically connected to the wireless control box 200 through wires, connecting the power line or relevant signal line.

The sensor module 330 includes one or more of a microphone 331, light sensor 332, camera 333, or infrared sensor 334. Among them:

Microphone 331: Enables smart voice interaction, allowing users to conveniently control the device through voice commands, enhancing the AI intelligence and ease of operation.

Light Sensor 332: Real-time detection of the ambient light intensity, allowing the wireless control box 200 to automatically adjust the brightness and other parameters of the lighting module 310 based on the light intensity, intelligently adapting to environmental changes and providing users with a comfortable and energy-efficient lighting environment.

Camera 333: Used for home smart monitoring, recording the conditions in the home in real-time, promptly detecting and alerting any abnormalities, thus providing reliable home security for users.

Infrared Sensor 334: Used to receive infrared remote control signals to operate the device 600.

Preferably, as shown in FIGS. 4 and 5, the tension rod smart home device 600 in this embodiment is also equipped with an LED decorative light 500. The LED decorative light 500 includes a lamp board bracket 513, an LED lamp board 512 mounted on the lamp board bracket 513, and LED beads 511 mounted on the LED lamp board 512. The lamp board bracket 513 securely installs the entire LED decorative light 500 to the tension rod 100. The LED lamp board 512 has multiple LED beads 511, and the LED lamp board 512 is electrically connected to the wireless control box 200. The wireless control box 200 can control the LED decorative light 500 to present various lighting effects, such as running lights.

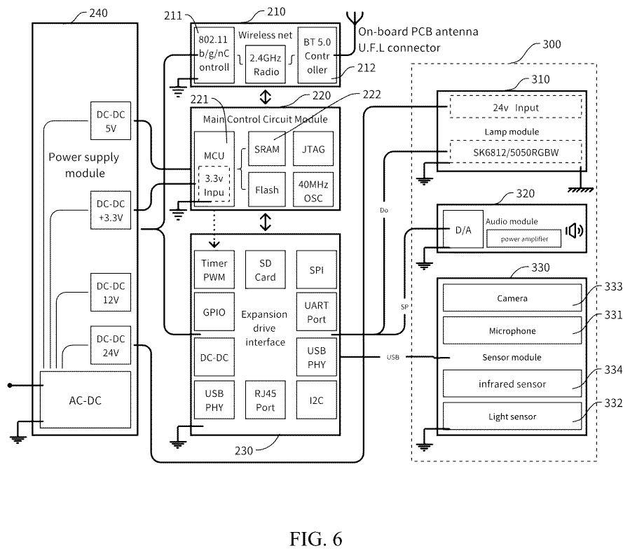

Referring to FIGS. 5 and 6, the wireless control box 200 in this embodiment includes a main control circuit module 220, a wireless network module 210 electrically connected to the main control circuit module 220, and an expansion drive interface 230. The expansion drive interface 230 is electrically connected to the functional execution module 300. The wireless control box 200 also includes a power supply module 240 that powers the main control circuit module 220, wireless network module 210, expansion drive interface 230, and functional execution module 300.

### Among Them:

Main Control Circuit Module 220: Includes a microprocessor 221 and a storage unit 222 electrically connected to the microprocessor 221, where the storage unit 222 stores the operating system and application programs.

Microprocessor 221: Responsible for executing programs, scheduling control of device operations, data processing, and storage, ensuring stable operation of the device and efficient information processing.

Storage Unit 222: Used to store the operating system and application programs necessary for device operation, as well as data and user settings needed for operation, ensuring that data can be called and updated at any time, maintaining the normal operation of the device and preserving personalized settings. The operating system provides a user-friendly human-computer interaction interface, supports functional expansion and personalization, facilitates user operation, and enables various smart controls and scene mode switching. The storage unit 222 can be SRAM, Flash, etc.

Wireless Network Module 210: Includes a WiFi module 211 and a Bluetooth module 212, as well as an antenna and radio remote control function, supporting device network access and control signal reception, enabling users to achieve remote control and intelligent operations.

Expansion Drive Interface 230: Includes one or more of SPI, I2C, USB, GPIO, UART interfaces, used to connect to the functional execution module 300, and can also connect to other expandable modules, making it compatible with different external devices. It also includes an SD card interface and an RJ45 interface; the SD card interface allows for storage expansion, while the RJ45 interface can connect to Ethernet via a wired network. This expansion drive interface 230 features standard IoT interfaces, allowing devices to interact with other smart hardware and expand more smart home application scenarios.

Power Supply Module 240: Provides stable power support for the entire device and expansion devices, ensuring continuous operation. It can be connected to various power sources, including batteries, solar panels, and AC mains.

The power supply module 240 in this embodiment outputs multiple DC working voltages, including 3.3V, 5V, 12V, and 24V, providing matching working voltages for different electronic components and expansion components of the device 600, eliminating the need for multiple power supplies.

### Implementation Example: Installation Process of Tension Rod Smart Home Device 600 in Buildings

Step 1: Adjust the retractable tension rod 100. Based on the vertical distance between two parallel surfaces 400 of the building, multiple short rods 111 are nested and fixed to form the main rod 110, ensuring that its length is approximately 10-40 cm shorter than the space. Then, insert the adjustment rod 120 and adjust it so that the extended length of the adjustment rod 120 is greater than the space by 3-5 cm. Next, install the main rod base 132 and the adjustment rod base 131, and finally axially compress and install it in the vertical direction between the two parallel surfaces 400 of the building. It is essential to ensure sufficient tension to create pressure against the two parallel surfaces, generating friction to secure the retractable tension rod 100. After verifying stability through a test installation, remove the rod again and install functional execution modules 300, such as the lighting module 310, audio module 320, and sensor module 330, on the rod body. Then, reinstall the retractable tension rod 100, which now includes the functional execution modules 300, between the previously prepared two parallel surfaces 400 of the building.

Step 2: Power on the device 600 and initialize the wireless control box 200. At this point, it can be connected to a civil AC power supply or a battery. After connecting the power supply, test whether the remote control can operate the device. Users can control basic functions such as turning lights on and off, adjusting light brightness and color, ultraviolet disinfection, infrared laser positioning, laser light operation, and adjusting the audio volume via the remote control.

Step 3: Activate the wireless network module 210, which includes WiFi and Bluetooth connections, allowing it to connect to the user's mobile terminal for smart device interaction control. For example, after connecting via Bluetooth, users can play music or control light switches and adjust brightness and color through a mobile app.

Step 4: Users can configure the WiFi network account for the wireless network module 210 through the app interface on their mobile terminal to ensure the device connects to the network. Through the IoT services in the network, interaction with other devices is possible, enabling intelligent IoT scenarios, such as integrating with TVs, air conditioners, vacuum cleaners, and automatic curtains.

Step 5: Once connected to the network, the microprocessor in the main control circuit module 220 and the software operating system can download relevant data from the network, enabling software upgrades, hardware driver updates, and new hardware driver integration.

Step 6: The sensor module 330 on the device 600 expands its spatial detection perspective downwards to achieve real-time environmental perception and signal reception. This includes voice recognition, detecting room occupancy, monitoring lighting conditions, identifying infrared heat anomalies, and even image AI recognition warnings through the camera.

Step 7: Once multiple devices 600 are connected to the network, users can configure their spatial positions via a mobile terminal. They can set synchronization or spatial relationships, such as the synchronization of multiple light changes or the spatial positioning of multiple audio channels (left and right).

Step 8: This leads to an overall IoT human-machine interaction scenario. This step involves configuring the spatial relationships of added devices, connecting multiple devices 600 to a server network, and integrating spatial information tagging with AR and VR devices. This allows for the combination of cloud-based IoT intelligence and local intelligence, enabling sound and light coordination based on spatial computing. It achieves higher levels of smart home control, home security monitoring, themed family parties, home theaters, karaoke, and even commercial entertainment scenarios.

In summary, implementation example one of the tension rod smart home device 600 achieves quick and damage-free installation, with high integration of various components. It provides lighting, audio, and multifunctional IoT environments, saving users from many installation, connection, and debugging hassles. Additionally, the device is installed high in the room, providing extensive spatial coverage downwards, achieving environmental perception and signal reception, while delivering excellent audiovisual effects, significantly enhancing users' visual and auditory experiences as well as human-computer interaction experiences.

### Implementation Example Two: Tension Rod Smart Home Device 600

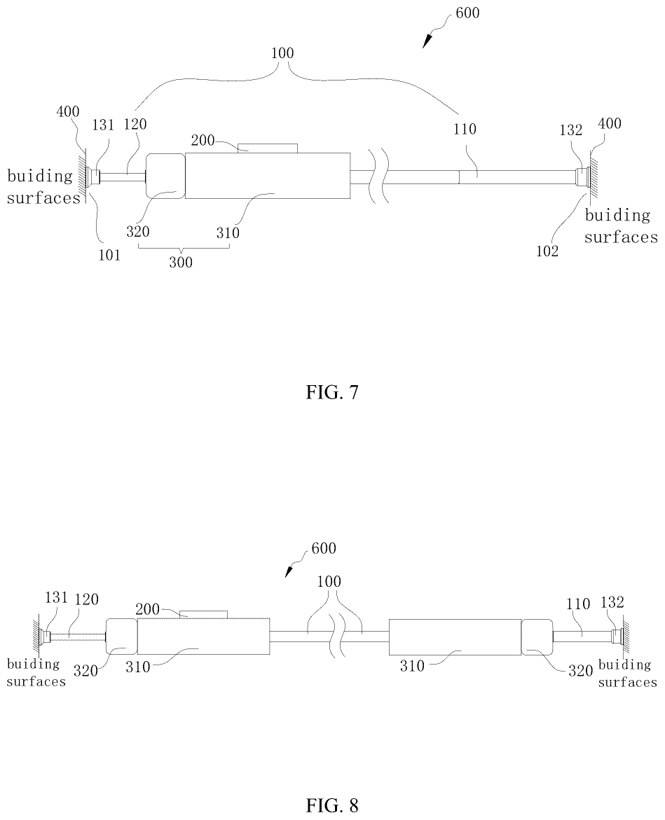

As shown in FIG. 7, this implementation example provides a tension rod smart home device 600, which differs from implementation example one in that the tension rod smart home device 600 in this example is installed horizontally in the building. The adjustment rod bases 131 and main rod bases 132 at both ends of the retractable tension rod 100 are respectively abutted against two horizontally parallel surfaces 400 of the building. The structural components of the tension rod smart home device 600 in implementation example two are essentially the same as those in implementation example one, and will not be repeated here.

The horizontal installation and usage process of the tension rod smart home device 600 in a building is as follows:

Installation Preparation: Adjust the length and angle of the retractable tension rod 100 to ensure it fits the installation space. Next, sequentially secure the lighting module 310 and the audio module 320 in suitable positions on the tension rod, connecting them with the wireless control box 200. Notably, ensure that the left and right positions of the audio are symmetrically adjusted.

Device Fixation: Compress and install the retractable tension rod 100 horizontally between the two parallel walls, ensuring sufficient tension generates enough friction to maintain stability.

Device Debugging: Power on the device and perform preliminary debugging on the lighting module 310 and audio module 320 through the wireless control box 200, ensuring that light control and Bluetooth audio playback operate normally, including that the sensor signals can drive the lighting to respond accordingly.

Network Configuration: Use the mobile terminal app to configure the WiFi network account for the wireless network module 210, enabling the device to connect to the home network for remote control and intelligent interactivity.

Scene Configuration: According to user needs, configure lighting effects, stereo sound modes, sensor linkage, and other scene modes in the app to enhance the user experience.

Daily Use: In daily use, users can adjust the device's operating state at any time through the app or remote control, enjoying a convenient smart home lifestyle.

Implementation example two demonstrates the application of the tension rod smart home device 600 in horizontal installation, combining the collaborative operation of the lighting module 310 and audio module 320 to achieve synchronized environmental lighting effects and music, providing users with an immersive audiovisual experience.

Implementation Example Three: As shown in FIG. 8, this implementation example provides a tension rod smart home device 600, which differs from implementation example one in that the tension rod smart home device 600 in implementation example two is installed horizontally in the building. The adjustment rod bases 131 and main rod bases 132 at both ends of the retractable tension rod 100 are respectively abutted against two horizontally parallel surfaces 400 of the building. On this basis, implementation example three further includes two lighting modules 310, two audio modules 320, and a sensor module 330, which can be installed horizontally between two parallel building surfaces.

The tension rod smart home device 600 in implementation example three includes two lighting modules 310 fixed on the retractable tension rod 100, adopting a left-right symmetrical installation method. The two lighting modules 310 are electrically connected to the wireless control box 200, ensuring the connection of power lines and related signal lines, thus allowing independent control of the lighting or synchronized pulsing with the audio.

Implementation Example Three: The tension rod smart home device 600 includes two audio modules 320 that are also fixed to the retractable tension rod 100, employing a left-right symmetrical installation method to achieve a stereo sound mode. Therefore, when electrically connected to the wireless control box 200, it is necessary to connect the stereo audio signal line or ensure the connection of the power supply and corresponding audio data signals. If digital audio is selected, the audio system will include compression decoding, digital-to-analog conversion, power amplification, and power management, all aimed at providing users with convenient audio streaming and high-quality listening experiences.

The tension rod smart home device 600 in implementation example three also includes a sensor module 330 to enable richer user scenario interactions and services. The sensor module 330 is fixed on the retractable tension rod 100.

Other structural components of the tension rod smart home device 600 in implementation example three are fundamentally the same as those in implementation example one, and will not be detailed again here.

The horizontal installation and usage process of the tension rod smart home device 600 in implementation example three is essentially the same as that of implementation example two and will not be reiterated here.

Implementation example three demonstrates the application of the tension rod smart home device 600 in horizontal installation, combining the collaborative operation of two lighting modules 310 and stereo audio module 320 to achieve synchronized environmental lighting effects and music, providing users with an immersive audiovisual experience.

Implementation examples two and three ingeniously perform horizontal, damage-free installations of the tension rod smart home device 600. The device can be installed above the television, providing extensive spatial coverage from a high position in the room, achieving better stereo sound performance, immersive light and sound synchronization, and a multifunctional IoT environment. This design saves users from the hassles of installation, connection, and debugging, significantly enhancing their quality of life.

In summary, the tension rod smart home device 600 proposed by this utility model demonstrates significant beneficial effects. The device achieves damage-free installation through physical tension and friction, and experimental evidence shows it can withstand at least 50 kg of axial pressure with excellent stability. The highly integrated design simplifies the system architecture, integrating multiple functional units. Experiments indicate the device maintains stable WiFi connections and responds quickly to control demands for multiple smart devices. The retractable tension rod allows users to flexibly adjust the height and position of the device as needed, making the adjustment process quick and convenient, leading to high user satisfaction. The built-in sensors and wireless communication modules support smart interactions, such as controlling the device with voice commands, thereby delivering an efficient smart home experience. The modular design makes device maintenance and upgrades more convenient, effectively reducing maintenance costs and enhancing user satisfaction. Furthermore, this utility model has a wide range of applications, suitable for various settings such as homes and offices, is environmentally friendly and economical, reduces construction waste and secondary renovation pollution, significantly lowering installation costs and shortening installation time. These advantages have been thoroughly validated through theoretical analysis and experimental data, demonstrating significant advancements in technology and application value.

The above descriptions are intended to clearly illustrate examples of this utility model and do not limit the scope of the patent for this utility model. It is not possible to exhaustively enumerate all implementation methods; any equivalent structural transformations made using the contents of the technical solutions in this utility model or direct/indirect applications in other related technical fields are included within the scope of patent protection of this utility model.

What is claimed is:

1. A tension rod smart home device, characterized by comprising a retractable tension rod, a wireless control box disposed on the retractable tension rod, and a functional execution module, wherein the functional execution module is electrically connected to the wireless control box, and the retractable tension rod comprises a first end and a second end located at two ends, respectively. The first end and the second end are pressed tightly against two building surfaces by tension, so that the tension rod smart home device is suspended between the two building surfaces, and the wireless control box receives external commands wirelessly and then controls the functional execution module to operate.

2. The tension rod smart home device according to claim 1, characterized in that the suspension is vertical, horizontal, or diagonal.

3. The tension rod smart home device according to claim 1, characterized in that the functional execution module comprises one or more of a lamp module, an audio module, and a sensor module.

4. The tension rod smart home device according to claim 1, characterized in that the retractable tension rod comprises a main rod and an adjustment rod connected to the main rod, wherein the adjustment rod has axial elasticity, and the adjustment rod is embedded into the main rod with an adjustable embedding length.

5. The tension rod smart home device according to claim 4, characterized in that the main rod is composed of multiple detachable short rods connected together.

6. The tension rod smart home device according to claim 4, characterized in that one end of the main rod in contact with the building surface is provided with a rotatable main rod base, and one end of the adjustment rod in contact with the building surface is provided with a rotatable adjustment rod base.

7. The tension rod smart home device according to claim 4, characterized in that the adjustment rod comprises a locking base, a spring, and an ejection rod connected in sequence, wherein the locking base and the spring are located inside the main rod, and one end of the ejection rod is located inside the main rod while the other end extends outside the main rod;
the main rod is axially distributed with multiple adjustment holes, and the locking base is provided with an ejection ball. After the ejection ball is embedded into the adjustment hole, the locking base is fixed to the main rod.

8. The tension rod smart home device according to claim 1, characterized in that the wireless control box comprises a main control circuit module, a wireless network module electrically connected to the main control circuit module, and an expansion drive interface, wherein the expansion drive interface is electrically connected to the functional execution module;
the wireless control box further comprises a power supply module that provides power to the main control circuit module, the wireless network module, the expansion drive interface, and the functional execution module.

9. The tension rod smart home device according to claim 8, characterized in that the main control circuit module comprises a microprocessor and a memory unit electrically connected to the microprocessor, wherein the memory unit stores an operating system and application programs.

10. The tension rod smart home device according to claim 8, characterized in that the expansion drive interface comprises one or more of SPI, I2C, USB, GPIO, and UART interfaces.

11. The tension rod smart home device according to claim 8, characterized in that the wireless network module comprises one or more of a WiFi module, a Bluetooth module, a LoRa module, a ZigBee module, and an NB-IoT module.

12. The tension rod smart home device according to claim 3, characterized in that the lamp module comprises a PCB metal heat sink substrate, a light-emitting unit disposed on the PCB metal heat sink substrate, an optical component, and a lampshade covering the PCB metal heat sink substrate, the light-emitting unit, and the optical component, wherein the optical component is positioned in the light-emitting direction of the light-emitting unit.

13. The tension rod smart home device according to claim 12, characterized in that the light-emitting unit comprises one or more of an illumination light source, an ultraviolet light source, an infrared light source, and a laser light source.

14. The tension rod smart home device according to claim 12, characterized in that the optical component comprises one or more of a lens, a Fresnel lens, an optical film, a reflective concentrator, and a grating for shaping and regulating light.

15. The tension rod smart home device according to claim 3, characterized in that the sensor module comprises one or more of a microphone, a light sensor, a camera, and an infrared sensor.
